(19) United States
(12) Patent Application Publication
(10) Pub. No.: US 2025/0094041 A1
(43) Pub. Date: Mar. 20, 2025

(54) Smart Character Suggestion via XR Cubic Keyboard on Head-mounted Devices

(71) Applicant: Meta Platforms, Inc., Menlo Park, CA (US)

(72) Inventor: Jiayang Xu, Seattle, WA (US)

(21) Appl. No.: 18/469,368

(22) Filed: Sep. 18, 2023

(51) Int. Cl. G06F 3/04886; G06F 3/01; G06F 3/03; G06F 3/0346; G06F 3/0482; G06F 3/0484

(52) U.S. Cl. CPC G06F 3/04886; G06F 3/015; G06F 3/0346; G06F 3/0482; G06F 3/0484; G06F 3/0304

(57) ABSTRACT

In one embodiment, a method includes receiving a first user input from a user from a client system comprising a head-mounted extended-reality (XR) device, determining the user's intent to activate an XR cubic keyboard based on the first user input, rendering the XR cubic keyboard via XR displays of the head-mounted XR device, wherein the XR cubic keyboard comprises input areas representing respective characters in a three-dimensional (3D) space, and wherein the input areas are reachable by respective vectors from a centroid of the XR cubic keyboard in the 3D space, receiving a second user input comprising a hand movement of the user along a direction of a first vector from the centroid of the XR cubic keyboard in the 3D space, determining a first character that the user intended to input, and rendering an indication of the first character via the XR displays.

### TECHNICAL FIELD

This disclosure generally relates to databases and file management within network environments, and in particular relates to audio signal processing for augmented-reality (AR) and virtual-reality (VR) systems.

### BACKGROUND

Augmented reality (AR) is an interactive experience of a real-world environment where the objects that reside in the real world are enhanced by computer-generated perceptual information, sometimes across multiple sensory modalities, including visual, auditory, haptic, somatosensory and olfactory. AR can be defined as a system that incorporates three basic features: a combination of real and virtual worlds, real-time interaction, and accurate 3D registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment. In this way, augmented reality alters one's ongoing perception of a real-world environment. Augmented reality is related to two largely synonymous terms: mixed reality and computer-mediated reality.

Virtual reality (VR) is a simulated experience that can be similar to or completely different from the real world. Applications of virtual reality include entertainment (particularly video games), education (such as medical or military training) and business (such as virtual meetings). Standard virtual reality systems use either virtual reality headsets or multi-projected environments to generate realistic images, sounds and other sensations that simulate a user's physical presence in a virtual environment. A person using virtual reality equipment is able to look around the artificial world, move around in it, and interact with virtual features or items. The effect is commonly created by VR headsets consisting of a head-mounted display with a small screen in front of the eyes but can also be created through specially designed rooms with multiple large screens. Virtual reality typically incorporates auditory and video feedback but may also allow other types of sensory and force feedback through haptic technology.

### SUMMARY OF PARTICULAR EMBODIMENTS

In particular embodiments, an AR/VR system may allow users wearing head-mounted devices with limited manual input functionality (e.g., AR glasses, VR headsets) to quickly invoke actions using the display and gestures by combining smart suggestions based on smart character suggestions with an easy-to-use extended-reality (XR) cubic keyboard. Extended reality (XR) is a catch-all term to refer to AR, VR, and mixed reality (MR). The technology is intended to combine or mirror the physical world with a “digital twin world” able to interact with it. The smart character suggestions may provide messaging, action, global search suggestions focusing on a single character (or a few more if necessary). The XR cubic keyboard may render all letters, numbers, or symbols in a way that is easily selectable by a user with rough gestures wearing an electromyography (EMG) wristband. Both smart character suggestions and XR cubic keyboard may help the user to complete the final action with fewer movements. With education, any character may be triggered by a single continuous movement, e.g., making a fist (or another gesture) and hitting a direction. Suggestions may be then triggered sequentially without further inputs. The user may only need to pick one suggestion if they are high quality. As an example and not by way of limitation, a user wearing AR glasses may receive a message from a friend, asking “How's Seattle?” The user may open the cubic keyboard with a fist gesture and select letter “C” with a movement along the corresponding direction. The AR glasses may then show some suggested actions corresponding to this single letter “C” selection. For example, these suggestions may include “colder than I thought”, “open camera”, “call Tom”, or “café near me”. The user may select “open camera” and take a photo. The user may then reply to their friend with the photo. Although this disclosure describes providing particular cubic keyboard by particular systems in a particular manner, this disclosure contemplated providing any suitable cubic keyboard by any suitable system in any suitable manner.

In particular embodiments, the AR/VR system may receive from a client system comprising a head-mounted extended-reality (XR) device, a first user input from a user. The AR/VR system may then determine, based on the first user input, an intent of the user to activate an XR cubic keyboard. In particular embodiments, the AR/VR system may render, via one or more XR displays of the head-mounted XR device, the XR cubic keyboard. The XR cubic keyboard may comprise a plurality of input areas representing a plurality of characters, respectively, in a three-dimensional (3D) space. The plurality of input areas may be reachable by a plurality of vectors, respectively, from a centroid of the XR cubic keyboard in the 3D space. In particular embodiments, the AR/VR system may receive, a second user input from the user. The second user input may comprise a hand movement of the user along a direction of a first vector of the plurality of vectors from the centroid of the XR cubic keyboard in the 3D space. The AR/VR system may then determine, based on the direction of the first vector with respect to the XR cubic keyboard in the 3D space, a first character of the plurality of characters that the user intended to input. The AR/VR system may further render, via the one or more XR displays, an indication of the first character.

Certain technical challenges exist for smart character suggestions via XR cubic keyboard. One technical challenge may include accurately detecting a user's intent to activate the XR cubic keyboard and a user's selection of a character. The solution presented by the embodiments disclosed herein to address this challenge may be using sensor signals from EMG wristbands or visual signals from cameras for such detections, as these signals may provide informative cues of the user's hand movements and gestures to determine their intents or selections of characters. Another technical challenge may include providing a simple yet effective way for a user to select a character. The solution presented by the embodiments disclosed herein to address this challenge may be designing the XR cubic keyboard as multiple (e.g., 26) cubis located in multiple (e.g., 3) planes in the 3D space, as the user's hand may easily move along different vectors from the centroid of the XR cubic keyboard to hit each of the characters in one or more two movements.

Certain embodiments disclosed herein may provide one or more technical advantages. A technical advantage of the embodiments may include allowing users wearing head-mounted devices with limited manual input functionality to quickly invoke actions using the display and gestures as the AR/VR system may combine smart character suggestions with the easy-to-use extended-reality (XR) cubic keyboard. Certain embodiments disclosed herein may provide none, some, or all of the above technical advantages. One or more other technical advantages may be readily apparent to one skilled in the art in view of the figures, descriptions, and claims of the present disclosure.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with an augmented-reality (AR)/virtual-reality (VR) system.

FIG. 2 illustrates an example augmented-reality (AR) system.

FIG. 3 illustrates an example virtual-reality (VR) system worn by a user.

FIG. 4A illustrates an example XR cubic keyboard.

FIG. 4B illustrates an example XR cubic keyboard corresponding alphabet letters.

FIG. 5A illustrates a user wearing a head-mounted XR device.

FIG. 5B illustrates the user activating the XR cubic keyboard.

FIG. 5C illustrates the user selecting a first letter.

FIG. 5D illustrates the user selecting a second letter.

FIG. 5E illustrates example smart character suggestions.

FIG. 5F illustrates an example selection of a smart character suggestion.

FIG. 5G illustrates another example selection of a smart character suggestion

FIG. 6 illustrates an example method for using an XR cubic keyboard for smart character suggestions.

FIG. 7 illustrates an example computer system.

### DESCRIPTION OF EXAMPLE EMBODIMENTS

### System Overview

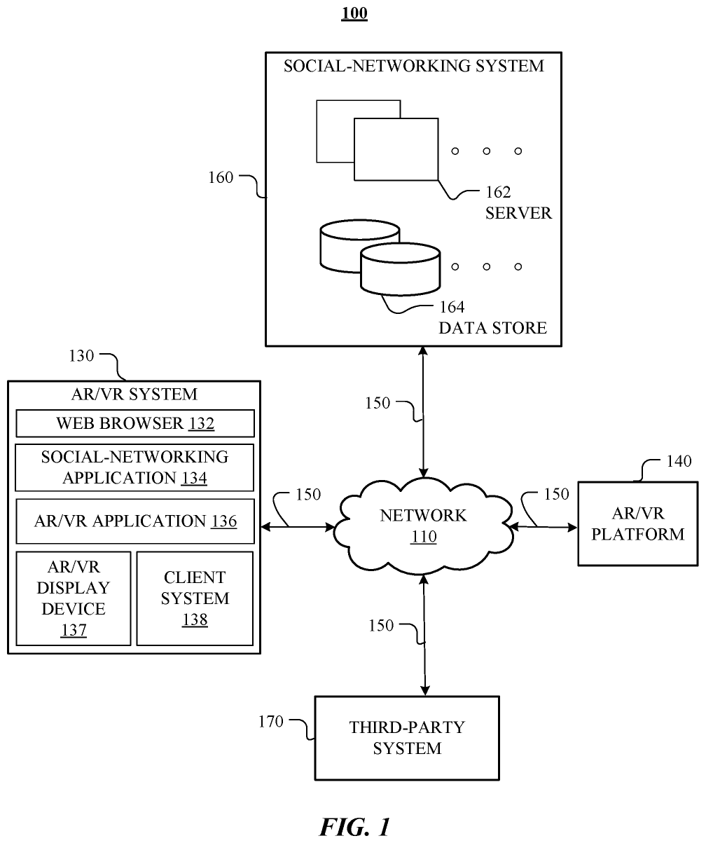

FIG. 1 illustrates an example network environment 100 associated with an augmented-reality (AR)/virtual-reality (VR) system 130. Network environment 100 includes the AR/VR system 130, an AR/VR platform 140, a social-networking system 160, and a third-party system 170 connected to each other by a network 110. Although FIG. 1 illustrates a particular arrangement of an AR/VR system 130, an AR/VR platform 140, a social-networking system 160, a third-party system 170, and a network 110, this disclosure contemplates any suitable arrangement of an AR/VR system 130, an AR/VR platform 140, a social-networking system 160, a third-party system 170, and a network 110. As an example and not by way of limitation, two or more of an AR/VR system 130, a social-networking system 160, an AR/VR platform 140, and a third-party system 170 may be connected to each other directly, bypassing a network 110. As another example, two or more of an AR/VR system 130, an AR/VR platform 140, a social-networking system 160, and a third-party system 170 may be physically or logically co-located with each other in whole or in part. Moreover, although FIG. 1 illustrates a particular number of AR/VR systems 130, AR/VR platforms 140, social-networking systems 160, third-party systems 170, and networks 110, this disclosure contemplates any suitable number of AR/VR systems 130, AR/VR platforms 140, social-networking systems 160, third-party systems 170, and networks 110. As an example and not by way of limitation, network environment 100 may include multiple AR/VR systems 130, AR/VR platforms 140, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular technology-based network, a satellite communications technology-based network, another network 110, or a combination of two or more such networks 110.

Links 150 may connect an AR/VR system 130, an AR/VR platform 140, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, an AR/VR system 130 may be any suitable electronic device including hardware, software, or embedded logic components, or a combination of two or more such components, and may be capable of carrying out the functionalities implemented or supported by an AR/VR system 130. As an example and not by way of limitation, the AR/VR system 130 may include a computer system such as a desktop computer, notebook or laptop computer, netbook, a tablet computer, e-book reader, GPS device, camera, personal digital assistant (PDA), handheld electronic device, cellular telephone, smartphone, smart speaker, smart watch, smart glasses, augmented-reality (AR) smart glasses, virtual-reality (VR) headset, other suitable electronic device, or any suitable combination thereof. This disclosure contemplates any suitable AR/VR systems 130. In particular embodiments, an AR/VR system 130 may enable a network user at an AR/VR system 130 to access a network 110. The AR/VR system 130 may also enable the user to communicate with other users at other AR/VR systems 130.

In particular embodiments, an AR/VR system 130 may include a web browser 132, and may have one or more add-ons, plug-ins, or other extensions. A user at an AR/VR system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to an AR/VR system 130 one or more Hyper Text Markup Language (HTML) files responsive to the HTTP request. The AR/VR system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, an AR/VR system 130 may include a social-networking application 134 installed on the AR/VR system 130. A user at an AR/VR system 130 may use the social-networking application 134 to access on online social network. The user at the AR/VR system 130 may use the social-networking application 134 to communicate with the user's social connections (e.g., friends, followers, followed accounts, contacts, etc.). The user at the AR/VR system 130 may also use the social-networking application 134 to interact with a plurality of content objects (e.g., posts, news articles, ephemeral content, etc.) on the online social network. As an example and not by way of limitation, the user may browse trending topics and breaking news using the social-networking application 134.

In particular embodiments, an AR/VR system 130 may include an AR/VR application 136. As an example and not by way of limitation, an AR/VR application 136 may be able to incorporate AR/VR renderings of real-world objects from the real-world environment into an AR/VR environment. A user at an AR/VR system 130 may use the AR/VR applications 136 to interact with the AR/VR platform 140. In particular embodiments, the AR/VR application 136 may comprise a stand-alone application. In particular embodiments, the AR/VR application 136 may be integrated into the social-networking application 134 or another suitable application (e.g., a messaging application). In particular embodiments, the AR/VR application 136 may be also integrated into the AR/VR system 130, an AR/VR hardware device, or any other suitable hardware devices. In particular embodiments, the AR/VR application 136 may be also part of the AR/VR platform 140. In particular embodiments, the AR/VR application 136 may be accessed via the web browser 132. In particular embodiments, the user may interact with the AR/VR platform 140 by providing user input to the AR/VR application 136 via various modalities (e.g., audio, voice, text, vision, image, video, gesture, motion, activity, location, orientation). The AR/VR application 136 may communicate the user input to the AR/VR platform 140. Based on the user input, the AR/VR platform 140 may generate responses. The AR/VR platform 140 may send the generated responses to the AR/VR application 136. The AR/VR application 136 may then present the responses to the user at the AR/VR system 130 via various modalities (e.g., audio, text, image, video, and VR/AR rendering). As an example and not by way of limitation, the user may interact with the AR/VR platform 140 by providing a user input (e.g., a verbal request for information of an object in the AR/VR environment) via a microphone of the AR/VR system 130. The AR/VR application 136 may then communicate the user input to the AR/VR platform 140 over network 110. The AR/VR platform 140 may accordingly analyze the user input, generate a response based on the analysis of the user input, and communicate the generated response back to the AR/VR application 136. The AR/VR application 136 may then present the generated response to the user in any suitable manner (e.g., displaying a text-based push notification and/or AR/VR rendering(s) illustrating the information of the object on a display of the AR/VR system 130).

In particular embodiments, an AR/VR system 130 may include an AR/VR display device 137 and, optionally, a client system 138. The AR/VR display device 137 may be configured to render outputs generated by the AR/VR platform 140 to the user. The client system 138 may comprise a companion device. The client system 138 may be configured to perform computations associated with particular tasks (e.g., communications with the AR/VR platform 140) locally (i.e., on-device) on the client system 138 in particular circumstances (e.g., when the AR/VR display device 137 is unable to perform said computations). In particular embodiments, the AR/VR system 130, the AR/VR display device 137, and/or the client system 138 may each be a suitable electronic device including hardware, software, or embedded logic components, or a combination of two or more such components, and may be capable of carrying out, individually or cooperatively, the functionalities implemented or supported by the AR/VR system 130 described herein. As an example and not by way of limitation, the AR/VR system 130, the AR/VR display device 137, and/or the client system 138 may each include a computer system such as a desktop computer, notebook or laptop computer, netbook, a tablet computer, e-book reader, GPS device, camera, personal digital assistant (PDA), handheld electronic device, cellular telephone, smartphone, smart speaker, virtual-reality (VR) headset, augmented-reality (AR) smart glasses, other suitable electronic device, or any suitable combination thereof. In particular embodiments, the AR/VR display device 137 may comprise a VR headset and the client system 138 may comprise a smart phone. In particular embodiments, the AR/VR display device 137 may comprise AR smart glasses and the client system 138 may comprise a smart phone.

In particular embodiments, a user may interact with the AR/VR platform 140 using the AR/VR display device 137 or the client system 138, individually or in combination. In particular embodiments, an application on the AR/VR display device 137 may be configured to receive user input from the user, and a companion application on the client system 138 may be configured to handle user inputs (e.g., user requests) received by the application on the AR/VR display device 137. In particular embodiments, the AR/VR display device 137 and the client system 138 may be associated with each other (i.e., paired) via one or more wireless communication protocols (e.g., Bluetooth).

The following example workflow illustrates how an AR/VR display device 137 and a client system 138 may handle a user input provided by a user. In this example, an application on the AR/VR display device 137 may receive a user input comprising a user request directed to the VR display device 137. The application on the AR/VR display device 137 may then determine a status of a wireless connection (i.e., tethering status) between the AR/VR display device 137 and the client system 138. If a wireless connection between the AR/VR display device 137 and the client system 138 is not available, the application on the AR/VR display device 137 may communicate the user request (optionally including additional data and/or contextual information available to the AR/VR display device 137) to the AR/VR platform 140 via the network 110. The AR/VR platform 140 may then generate a response to the user request and communicate the generated response back to the AR/VR display device 137. The AR/VR display device 137 may then present the response to the user in any suitable manner. Alternatively, if a wireless connection between the AR/VR display device 137 and the client system 138 is available, the application on the AR/VR display device 137 may communicate the user request (optionally including additional data and/or contextual information available to the AR/VR display device 137) to the companion application on the client system 138 via the wireless connection. The companion application on the client system 138 may then communicate the user request (optionally including additional data and/or contextual information available to the client system 138) to the AR/VR platform 140 via the network 110. The AR/VR platform 140 may then generate a response to the user request and communicate the generated response back to the client system 138. The companion application on the client system 138 may then communicate the generated response to the application on the AR/VR display device 137. The AR/VR display device 137 may then present the response to the user in any suitable manner. In the preceding example workflow, the AR/VR display device 137 and the client system 138 may each perform one or more computations and/or processes at each respective step of the workflow. In particular embodiments, performance of the computations and/or processes disclosed herein may be adaptively switched between the AR/VR display device 137 and the client system 138 based at least in part on a device state of the AR/VR display device 137 and/or the client system 138, a task associated with the user input, and/or one or more additional factors. As an example and not by way of limitation, one factor may be signal strength of the wireless connection between the AR/VR display device 137 and the client system 138. For example, if the signal strength of the wireless connection between the AR/VR display device 137 and the client system 138 is strong, the computations and processes may be adaptively switched to be substantially performed by the client system 138 in order to, for example, benefit from the greater processing power of the CPU of the client system 138. Alternatively, if the signal strength of the wireless connection between the AR/VR display device 137 and the client system 138 is weak, the computations and processes may be adaptively switched to be substantially performed by the AR/VR display device 137 in a standalone manner. In particular embodiments, if the AR/VR system 130 does not comprise a client system 138, the aforementioned computations and processes may be performed solely by the AR/VR display device 137 in a standalone manner.

In particular embodiments, the AR/VR platform 140 may comprise a backend platform or server for the AR/VR system 130. The AR/VR platform 140 may interact with the AR/VR system 130, and/or the social-networking system 160, and/or the third-party system 170 when executing tasks.

In particular embodiments, the social-networking system 160 may be a network-addressable computing system that can host an online social network. The social-networking system 160 may generate, store, receive, and send social-networking data, such as, for example, user profile data, concept-profile data, social-graph information, or other suitable data related to the online social network. The social-networking system 160 may be accessed by the other components of network environment 100 either directly or via a network 110. As an example and not by way of limitation, an AR/VR system 130 may access the social-networking system 160 using a web browser 132 or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. As an example and not by way of limitation, each server 162 may be a web server, a news server, a mail server, a message server, an advertising server, a file server, an application server, an exchange server, a database server, a proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable an AR/VR system 130, a social-networking system 160, an AR/VR platform 140, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes-which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. As an example and not by way of limitation, the entity operating the third-party system 170 may be a developer for one or more AR/VR applications 136. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. As an example and not by way of limitation, the third-party content object provider may be a developer for one or more AR/VR applications 136. A third-party content object provider may include one or more sources of content objects, which may be communicated to an AR/VR system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects. As yet another example and not by way of limitation, content objects may include one or more AR/VR applications 136. In particular embodiments, a third-party content provider may use one or more third-party agents to provide content objects and/or services. A third-party agent may be an implementation that is hosted and executing on the third-party system 170.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from an AR/VR system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more AR/VR systems 130 or one or more third-party systems 170 via a network 110. The web server may include a mail server or other messaging functionality for receiving and routing messages between the social-networking system 160 and one or more AR/VR systems 130. An API-request server may allow, for example, an AR/VR platform 140 or a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to an AR/VR system 130. Information may be pushed to an AR/VR system 130 as notifications, or information may be pulled from an AR/VR system 130 responsive to a user input comprising a user request received from an AR/VR system 130. Authorization servers may be used to enforce one or more privacy settings of the users of the social-networking system 160. A privacy setting of a user may determine how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from AR/VR systems 130 associated with users. Advertisement-pricing modules may combine social information, the current time, location information, or other suitable information to provide relevant advertisements, in the form of notifications, to a user.

### Augmented-Reality Systems

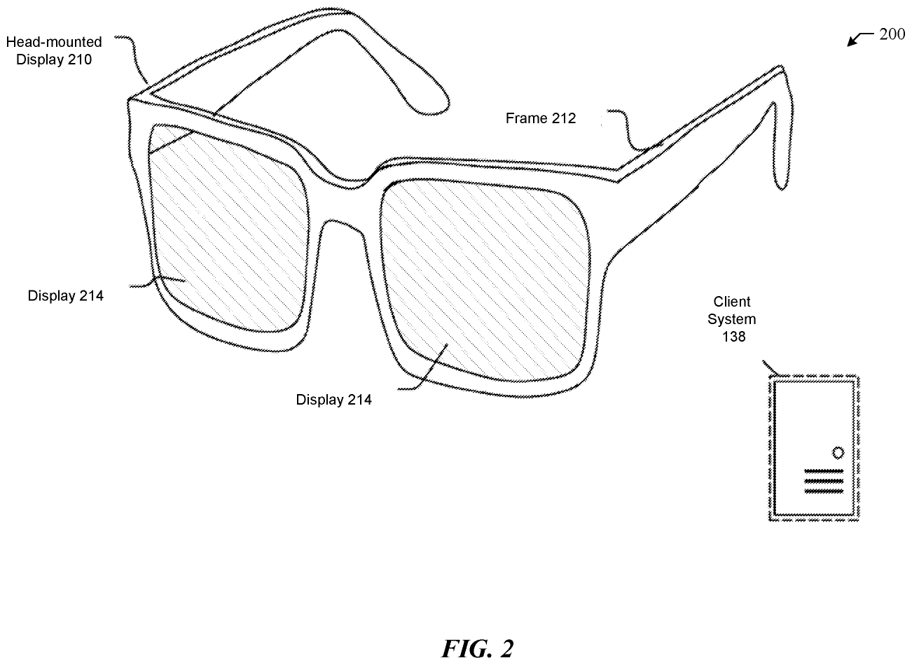

FIG. 2 illustrates an example augmented-reality system 200. In particular embodiments, the augmented-reality system 200 can perform one or more processes as described herein. The augmented-reality system 200 may include a head-mounted display (HMD) 210 (e.g., glasses) comprising a frame 212, one or more displays 214, and a client system 138. The displays 214 may be transparent or translucent allowing a user wearing the HMD 210 to look through the displays 214 to see the real world and displaying visual artificial reality content to the user at the same time. The HMD 210 may include an audio device that may provide audio artificial reality content to users. The HMD 210 may include one or more cameras which can capture images and videos of environments. The HMD 210 may include an eye tracking system to track the vergence movement of the user wearing the HMD 210. The HMD 210 may include a microphone to capture voice input from the user. The augmented-reality system 200 may further include a controller comprising a trackpad and one or more buttons. The controller may receive inputs from users and relay the inputs to the client system 138. The controller may also provide haptic feedback to users. The client system 138 may be connected to the HMD 210 and the controller through cables or wireless connections. The client system 138 may control the HMD 210 and the controller to provide the augmented-reality content to and receive inputs from users. The client system 138 may be a standalone host computer device, an on-board computer device integrated with the HMD 210, a mobile device, or any other hardware platform capable of providing augmented-reality content to and receiving inputs from users.

Object tracking within the image domain is a known technique. For example, a stationary camera may capture a video of a moving object, and a computing system may compute, for each frame, the 3D position of an object of interest or one of its observable features relative to the camera. When the camera is stationary, any change in the object's position is attributable only to the object's movement and/or jitter caused by the tracking algorithm. In this case, the motion of the tracked object could be temporally smoothed by simply applying a suitable averaging algorithm (e.g., averaging with an exponential temporal decay) to the current estimated position of the object and the previously estimated position(s) of the object.

Motion smoothing becomes much more complex in the context of augmented reality. For augmented-reality systems, an external-facing camera is often mounted on the HMD and, therefore, could be capturing a video of another moving object while moving with the user's head. When using such a non-stationary camera to track a moving object, the tracked positional changes of the object could be due to not only the object's movements but also the camera's movements. Therefore, the aforementioned method for temporally smoothing the tracked positions of the object would no longer work.

### Virtual-Reality Systems

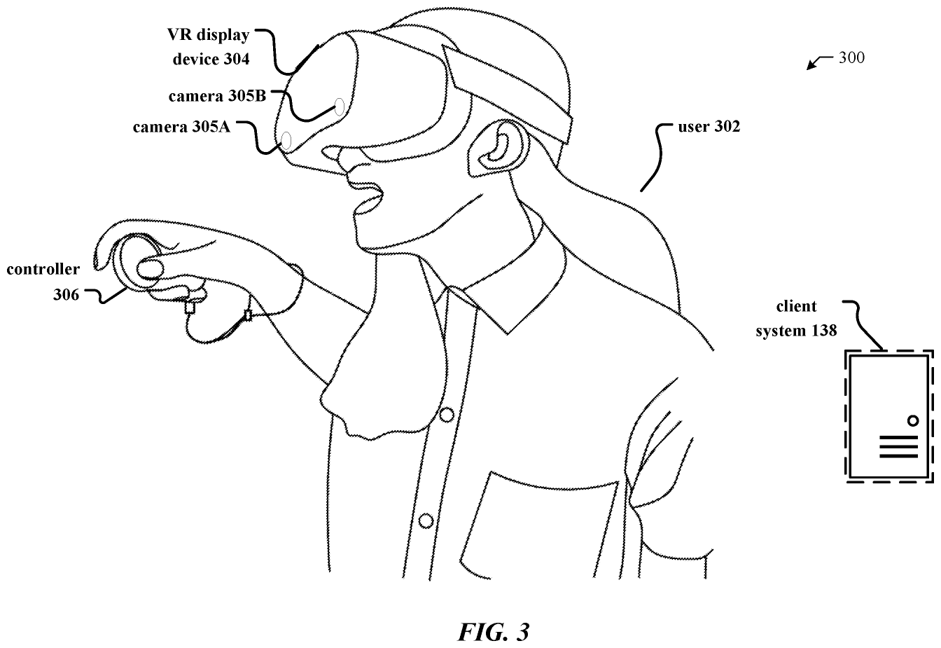

FIG. 3 illustrates an example of a virtual reality (VR) system 300 worn by a user 302. In particular embodiments, the VR system 300 may comprise a head-mounted VR display device 304, a controller 306, and one or more client systems 138. The VR display device 304 may be worn over the user's eyes and provide visual content to the user 302 through internal displays (not shown). The VR display device 304 may have two separate internal displays, one for each eye of the user 302 (single display devices are also possible). In particular embodiments, the VR display device 304 may comprise one or more external-facing cameras, such as the two forward-facing cameras 305A and 305B, which can capture images and videos of the real-world environment. The VR system 300 may further include one or more client systems 138. The one or more client systems 138 may be a stand-alone unit that is physically separate from the VR display device 304 or the client systems 138 may be integrated with the VR display device 304. In embodiments where the one or more client systems 138 are a separate unit, the one or more client systems 138 may be communicatively coupled to the VR display device 304 via a wireless or wired link. The one or more client systems 138 may be a high-performance device, such as a desktop or laptop, or a resource-limited device, such as a mobile phone. A high-performance device may have a dedicated GPU and a high-capacity or constant power source. A resource-limited device, on the other hand, may not have a GPU and may have limited battery capacity. As such, the algorithms that could be practically used by a VR system 300 depends on the capabilities of its one or more client systems 138.

### Smart Character Suggestion Via XR Cubic Keyboard on Head-Mounted Devices

In particular embodiments, the AR/VR system 130 may allow users wearing head-mounted devices with limited manual input functionality (e.g., AR glasses, VR headsets) to quickly invoke actions using the display and gestures by combining smart suggestions based on smart character suggestions with an easy-to-use extended-reality (XR) cubic keyboard. Extended reality (XR) is a catch-all term to refer to AR, VR, and mixed reality (MR). The technology is intended to combine or mirror the physical world with a “digital twin world” able to interact with it. The smart character suggestions may provide messaging, action, global search suggestions focusing on a single character (or a few more if necessary). The XR cubic keyboard may render all letters, numbers, or symbols in a way that is easily selectable by a user with rough gestures wearing an electromyography (EMG) wristband. Both smart character suggestions and XR cubic keyboard may help the user to complete the final action with fewer movements. With education, any character may be triggered by a single continuous movement, e.g., making a fist (or another gesture) and hitting a direction. Suggestions may be then triggered sequentially without further inputs. The user may only need to pick one suggestion if they are high quality. As an example and not by way of limitation, a user wearing AR glasses may receive a message from a friend, asking “How's Seattle?” The user may open the cubic keyboard with a fist gesture and select letter “C” with a movement along the corresponding direction. The AR glasses may then show some suggested actions corresponding to this single letter “C” selection. For example, these suggestions may include “colder than I thought”, “open camera”, “call Tom”, or “café near me”. The user may select “open camera” and take a photo. The user may then reply to their friend with the photo. Although this disclosure describes providing particular cubic keyboard by particular systems in a particular manner, this disclosure contemplated providing any suitable cubic keyboard by any suitable system in any suitable manner.

In particular embodiments, the AR/VR system 130 may receive, from a client system 138 comprising a head-mounted extended-reality (XR) device, a first user input from a user. The AR/VR system 130 may then determine, based on the first user input, an intent of the user to activate an XR cubic keyboard. In particular embodiments, the AR/VR system 130 may render, via one or more XR displays of the head-mounted XR device, the XR cubic keyboard. The XR cubic keyboard may comprise a plurality of input areas representing a plurality of characters, respectively, in a three-dimensional (3D) space. The plurality of input areas may be reachable by a plurality of vectors, respectively, from a centroid of the XR cubic keyboard in the 3D space. In particular embodiments, the AR/VR system 130 may receive, a second user input from the user. The second user input may comprise a hand movement of the user along a direction of a first vector of the plurality of vectors from the centroid of the XR cubic keyboard in the 3D space. The AR/VR system 130 may then determine, based on the direction of the first vector with respect to the XR cubic keyboard in the 3D space, a first character of the plurality of characters that the user intended to input. The AR/VR system 130 may further render, via the one or more XR displays, an indication of the first character.

When voice commands are not convenient or possible (e.g., a user is in a noisy environment, a user is in a library, an input or a response requires visual content, etc.), how to allow users wearing XR headsets (e.g., AR glasses or VR headsets) to quickly invoke actions using the display and gestures is a problem that needs to be solved. Projecting some type of two-dimensional (2D) keyboard or palm keyboard is possible, but such approach may be more power intensive to render and process inputs. XR headsets may come with EMG wristbands for users to wear so one may take advantage of EMG wristbands to input text. In other words, the first and second user inputs may be received via the EMG wristband. However, fine gesture input (e.g., typing a key) may be challenging with EMG wristband so it may be necessary to have a way to allow users to effectively input letters, numbers, symbols, and even emojis using broader gestures.

Taking inputting letters as an example, a solution by the embodiments disclosed herein may be rendering all letters on a keyboard in a way that is easily selectable by a user with rough gestures wearing an EMG wristband. For such purpose, the AR/VR system 130 may combine smart suggestions based on smart character suggestions with an easy-to-use XR cubic keyboard. This solution may be implemented in both AR and VR use cases. In addition, this solution may be applicable to not only English alphabet, but also any other suitable type of character input (e.g., foreign language).

The solution of the embodiments disclosed herein may be based on two components. One component may include an XR cubic keyboard and another component may include smart character suggestions. In particular embodiments, the XR cubic keyboard may provide an XR keyboard solution to allow a user to hit any character in one or two movements (detected, e.g., by the EMG wristband or hand-tracking techniques). In particular embodiments, each of the plurality of characters may comprise one or more of a letter, a number, a symbol, a word, a phrase, an emoji, or any suitable character.

Smart character suggestions may provide messaging, action, global search suggestions focusing on a single character (or possibly a word or a term). In particular embodiments, smart character suggestions may be not integrated into a keyboard that is called out only for input boxes, but instead work in a global manner. The user may simply select a single letter (or possibly two letters) on an English-alphabet keyboard (or any other suitable language). Responsive to the user's selection, the AR/VR system 130 may smartly provide suggestions of commands for completing various tasks.

In particular embodiments, the plurality of input areas may comprise 26 cubis. Intuitively, the XR cubic keyboard may be analogous to a Rubik's cube, which has 3×3×3=27 cubes, including the center cube/axes. Starting from the center, any one of the 26 surrounding cubes may be just one move away. In particular embodiments, the plurality of vectors may comprise 26 vectors from the centroid of the XR cubic keyboard in the 3D space. Then the hand movement of the user may be along a direction of a first vector of the 26 vectors from the centroid of the XR cubic keyboard in the 3D space. As an example and not by way of limitation, the XR cubic keyboard may place the 26 letters of the English alphabet at the center of each face, edge, and vertex of a 3×3×3 cube (26 vectors). Then a simple cosine similarity may be used to work in aligning hand movements with three−dimensional (3D) unit-length vectors such as (0,1,0), (−1,−1,1), etc. In particular embodiments, 9 first cubis of the 26 cubis may be located on a top plane in the 3D space. 8 second cubis of the 26 cubis may be located on a middle plane in the 3D space. 9 third cubis of the 26 cubis may be located on a bottom plane in the 3D space. Designing the XR cubic keyboard as multiple (e.g., 26) cubis located in multiple (e.g., 3) planes in the 3D space may be an effective solution for addressing the technical challenge of providing a simple yet effective way for a user to select a character, as the user's hand may easily move along different vectors from the centroid of the XR cubic keyboard to hit each of the characters in one or more two movements.

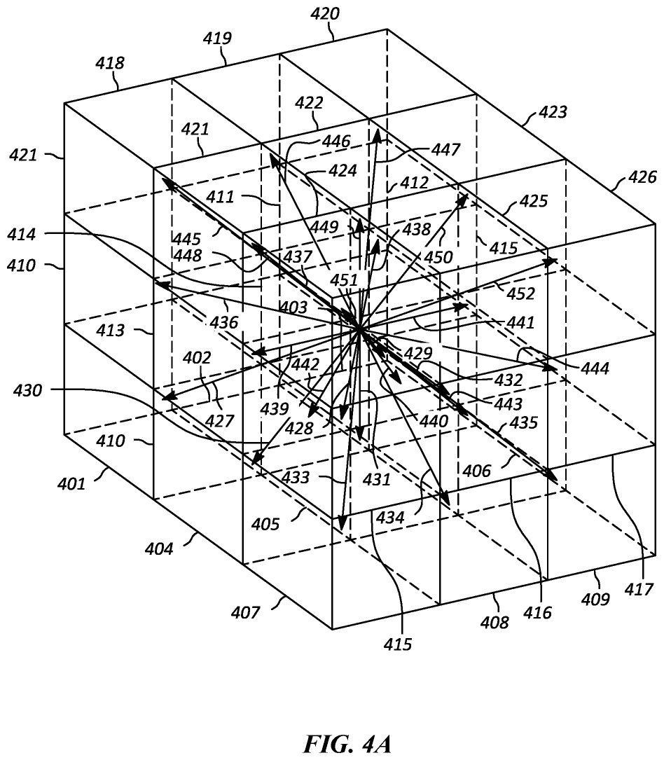

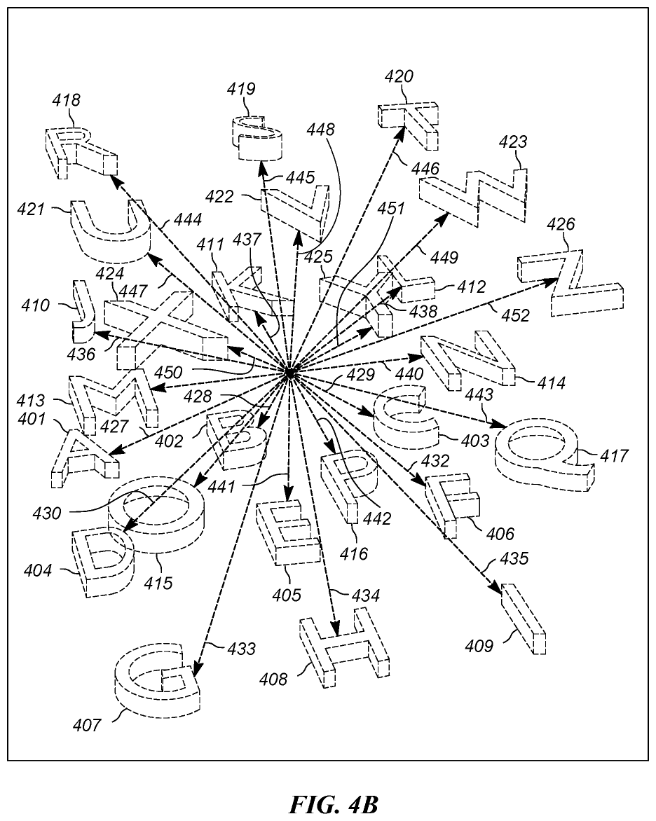

FIG. 4A illustrates an example XR cubic keyboard. As illustrated in FIG. 4A, there may be 26 cubis representing 26 input areas, which are labeled from 401 to 426. Cube 401 to cube 409 may be at the bottom plane. Cube 410 to cube 417 may be at the middle plane. Cube 418 to cube 426 may be at the top plane. FIG. 4A also shows the 26 vectors from the centroid, along each of which a user may select a corresponding cube. For example, the user may select cube 401 along vector 427, cube 402 along vector 428, cube 403 along vector 429, cube 404 along vector 430, cube 405 along vector 431, cube 406 along vector 432, cube 407 along vector 433, cube 408 along vector 434, cube 409 along vector 435, cube 410 along vector 436, cube 411 along vector 437, cube 412 along vector 438, cube 413 along vector 439, cube 414 along vector 440, cube 415 along vector 441, cube 416 along vector 442, cube 417 along vector 443, cube 418 along vector 444, cube 419 along vector 445, cube 420 along vector 446, cube 421 along vector 447, cube 422 along vector 448, cube 423 along vector 449, cube 424 along vector 450, cube 425 along vector 451, and cube 426 along vector 452.

FIG. 4B illustrates an example XR cubic keyboard corresponding alphabet letters. As illustrated in FIG. 4, the 26 cubis now represent 26 alphabet letters, i.e., “A” 401, “B”, 402, “C” 403, “D” 404, “E” 405, “F” 406, “G” 407, “H” 408, “I” 409, “J” 410, “K” 411, “L” 412, “M” 413, “N” 414, “O” 415, “P” 416, “Q” 417, “R” 418, “S” 419, “T” 420, “U” 421, “V” 422, “W” 423, “X” 424, “Y” 425, and “Z” 426. Letters “A” 401 to “I” 409 may be at the bottom plane. Letters “J” 410 to “Q” 417 may be at the middle plane. Letters “R” 418 to “Z” 426 may be at the top plane. FIG. 4B also shows the 26 vectors from the centroid, along each of which a user may select a corresponding letter. For example, the user may select “A” 401 along vector 427, “B” 402 along vector 428, “C” 403 along vector 429, “D” 404 along vector 430, “E” 405 along vector 431, “F” 406 along vector 432, “G” 407 along vector 433, “H” 408 along vector 434, “I” 409 along vector 435, “J” 410 along vector 436, “K” 411 along vector 437, “L” 412 along vector 438, “M” 413 along vector 439, “N” 414 along vector 440, “O” 415 along vector 441, “P” 416 along vector 442, “Q” 417 along vector 443, “R” 418 along vector 444, “S” 419 along vector 445, “T” 420 along vector 446, “U” 421 along vector 447, “V” 422 along vector 448, “W” 423 along vector 449, “X” 424 along vector 450, “Y” 425 along vector 451, and “Z” 426 along vector 452.

An example process to use the XR cubic keyboard may be as follows. A user may use the fist gesture to bring up the XR cubic keyboard, and again use the fist to strike a character. In particular embodiments, rather than needing the user to move their entire fist, the user may just point with a finger, which may be sufficient for the AR/VR system 130 to activate the XR cubic keyboard and select a character by using EMG technologies.

In particular embodiments, the AR/VR system 130 may determine the hand movement based on signals from the EMG wristband. The EMG wristband may comprise one or more inertial measurement unit (IMU) sensors. Accordingly, the AR/VR system 130 may determine the direction of the first vector with respect to the XR cubic keyboard in the 3D space based on signals from the one or more IMU sensors. In particular embodiments, the head-mounted XR device may be associated with one or more cameras. Accordingly, the AR/VR system 130 may receive, from the one or more cameras, visual signals captured by the one or more cameras. The AR/VR system 130 may further determine, based on the visual signals by one or more machine-learning models, the hand movement. Using sensor signals from EMG wristbands or visual signals from cameras for such detections may be an effectively solution for addressing the technical challenge may include accurately detecting a user's intent to activate the XR cubic keyboard and a user's selection of a character, as these signals may provide informative cues of the user's hand movements and gestures to determine their intents or selections of characters.

In particular embodiments, the AR/VR system 130 may enable a user to conduct multi-character selection by dragging their finger/fist from character to character and then making a finishing gesture to end the input.

In particular embodiments, the user may activate the XR cubic keyboard in a variety of ways as follows. The first user input may comprise one or more of a gesture, a press on a button on the head-mounted XR device, or a voice input. In one example embodiment, the AR/VR system 130 may recognize special gestures as the user's intent to activate the XR cubic keyboard. As an example and not by way of limitation, these gestures may include opening hand, pinching particular fingers together (e.g., detected by EMG wristband or hand/finger movement tracking by computer-vision technologies), or shaking wrist (if the user is wearing EMG wristband, which detects the wrist shaking based on signals from inertial measurement units).

In another example embodiment, the user may activate the XR cubic keyboard with a particular button on the head-mounted device or a touch captive sensor on the head-mounted device. As an example and not by way of limitation, in VR use cases, the user may press a button and use hand movement or a controller directional pad to input letters.

In yet another example embodiment, the user may activate the XR cubic keyboard by voice. As an example and not by way of limitation, the user may use an assistant system and say “Hey assistant, open the keyboard.”

In yet another example embodiment, the AR/VR system 130 may activate the XR cubic keyboard responsive to certain applications being opened. As an example and not by way of limitation, the user opening a messaging app may cause the XR cubic keyboard to automatically open.

In particular embodiments, the user may use different approaches to input characters. As an example and not by way of limitation, one approach for the user may be simply moving their hand along a vector in the direction of the character. As another example and not by way of limitation, another approach may need the user to move their hand and then perform a gesture (such as grabbing the character). In particular embodiments, the user may use a predefined gesture to delete an inputted character.

In particular embodiments, the AR/VR system 130 may receive, from the client system 138, a third user input via an electromyography (EMG) wristband. The third user input may comprise a gesture. The AR/VR system 130 may further determine, based on the gesture, the user confirms a selection of the first character.

In particular embodiments, the AR/VR system 130 may confirm with the user about inputted characters. The AR/VR system 130 may render a confirmation with the user of the selected first character. As an example and not by way of limitation, the rendering may be based on one or more of a visual display of the selected first character on the one or more XR displays, a haptic feedback, or an audio feedback. For example, the AR/VR system 130 may generate a visual display of the inputted characters (e.g., a text input box). The AR/VR system 130 may also confirm the user's selection of a character with haptic feedback (e.g., in EMG wristband), visual feedback (e.g., letter flashing or changing size, etc.), or audio feedback (e.g., audible click).

As disclosed above, the AR/VR system 130 may provide smart character suggestions once the user selects a character. As an example and not by way of limitation, the user selected character may be “c”. In particular embodiments, the AR/VR system 130 may generate, based on the first character, one or more candidate commands for the user. The AR/VR system 130 may then render one or more of the candidate commands. As an example and not by way of limitation, the candidate commands for the selected character “c” may be “call Dad,” “cancel appointment,” etc. In particular embodiments, the rendering may be based on one or more of a visual display of the one or more of the candidate commands on the one or more XR displays or a readout of the one or more of the candidate commands. The AR/VR system 130 may then receive, from the client system 138, a user selection of a first candidate command of the rendered candidate commands. As an example and not by way of limitation, the user selected candidate command may be “call Dad.” In particular embodiments, the AR/VR system 130 may determine a first task corresponding to the first candidate command. The AR/VR system 130 may further execute the first task. As an example and not by way of limitation, the AR/VR system 130 may initiate a call to the user's Dad. As a result, the embodiments disclosed herein may have a technical advantage of allowing users wearing head-mounted devices with limited manual input functionality to quickly invoke actions using the display and gestures as the AR/VR system 130 may combine smart character suggestions with the easy-to-use extended-reality (XR) cubic keyboard.

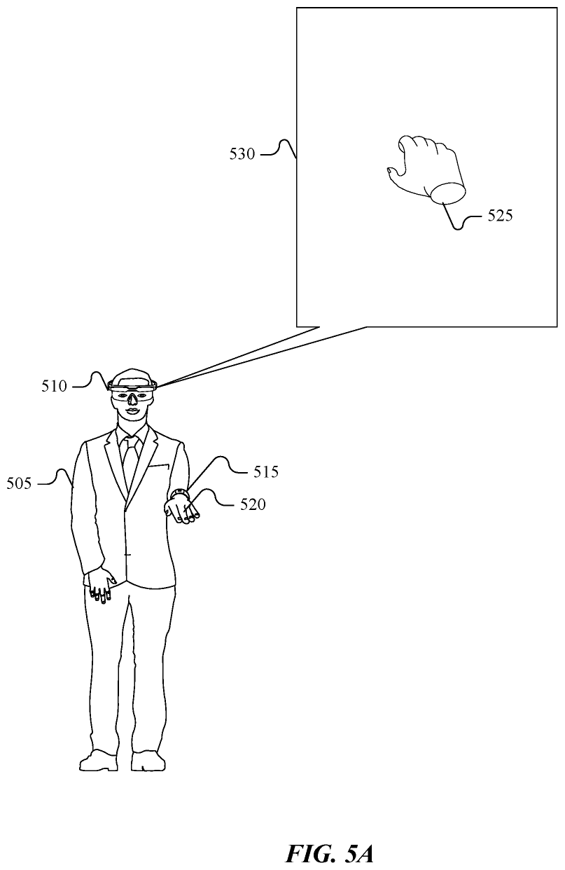

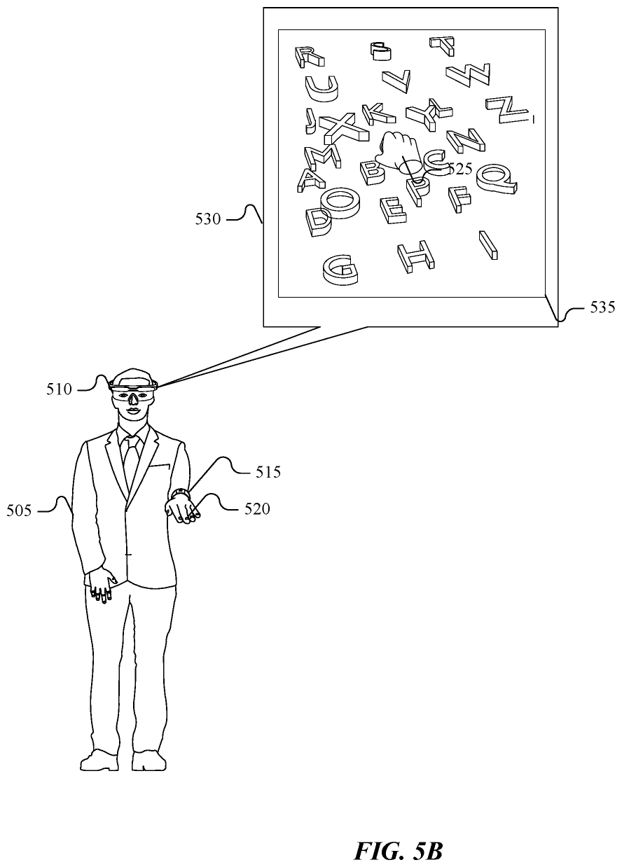

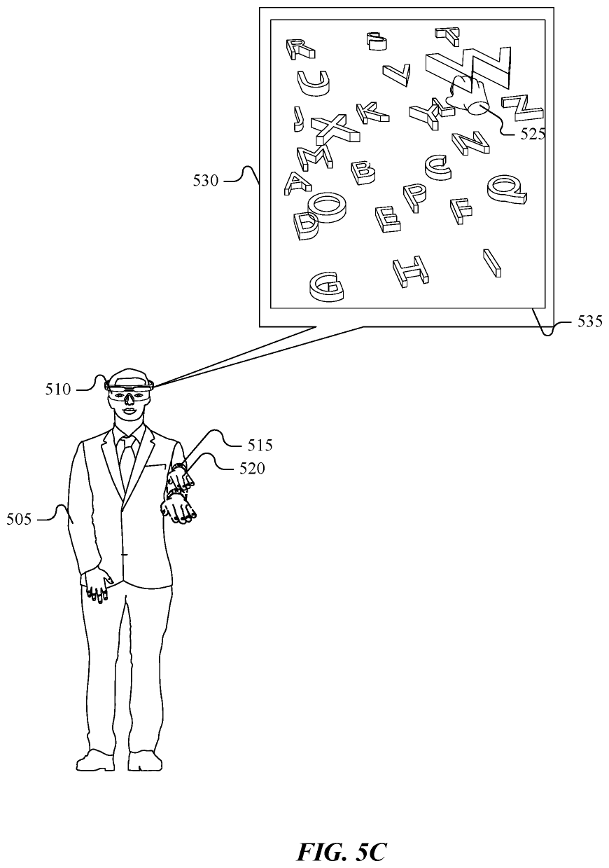

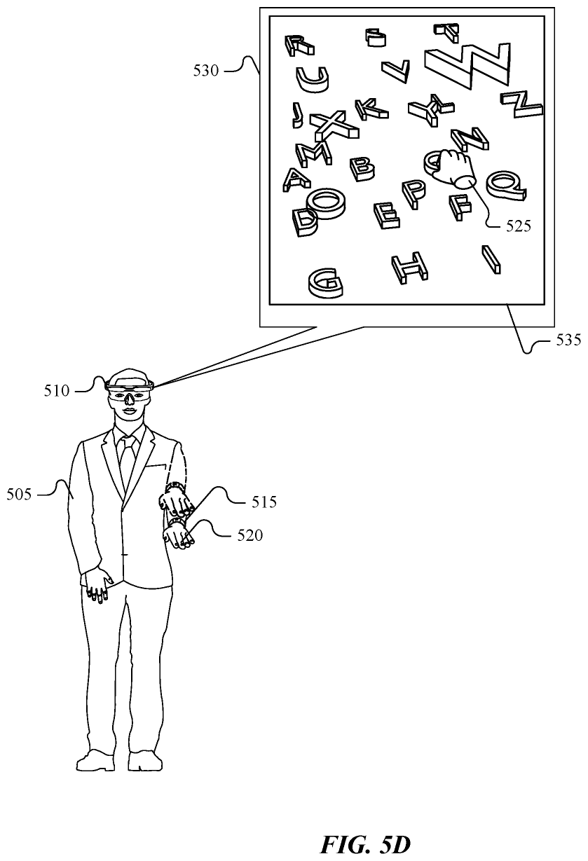

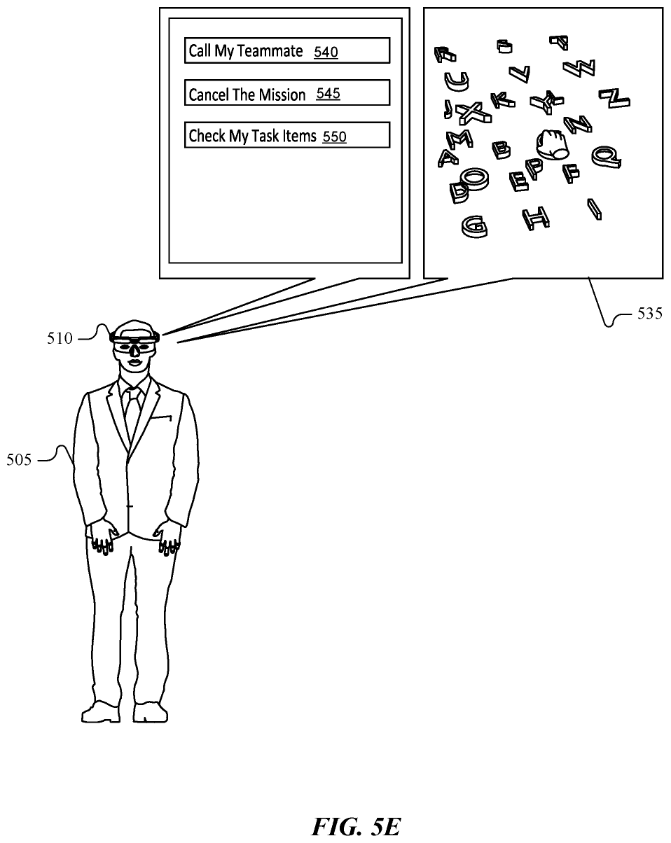

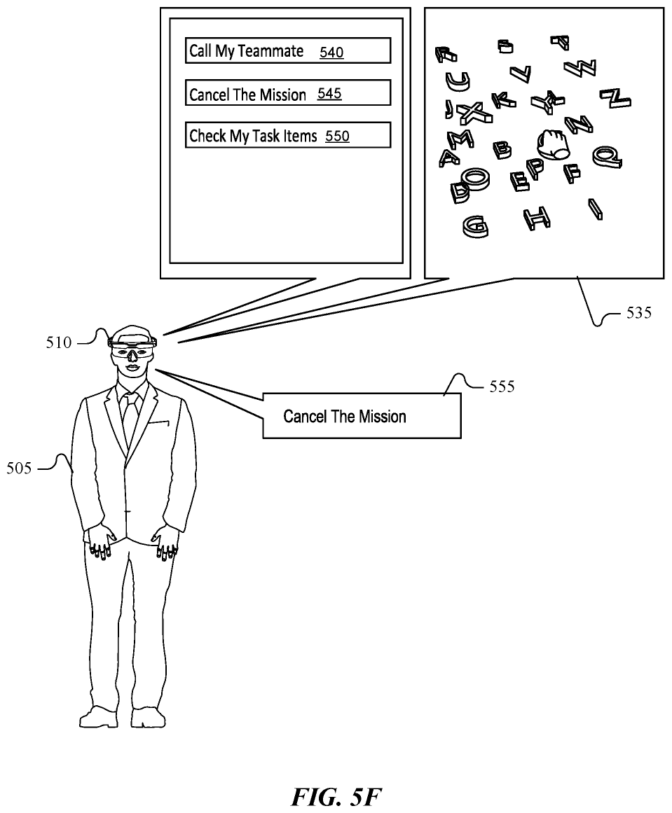

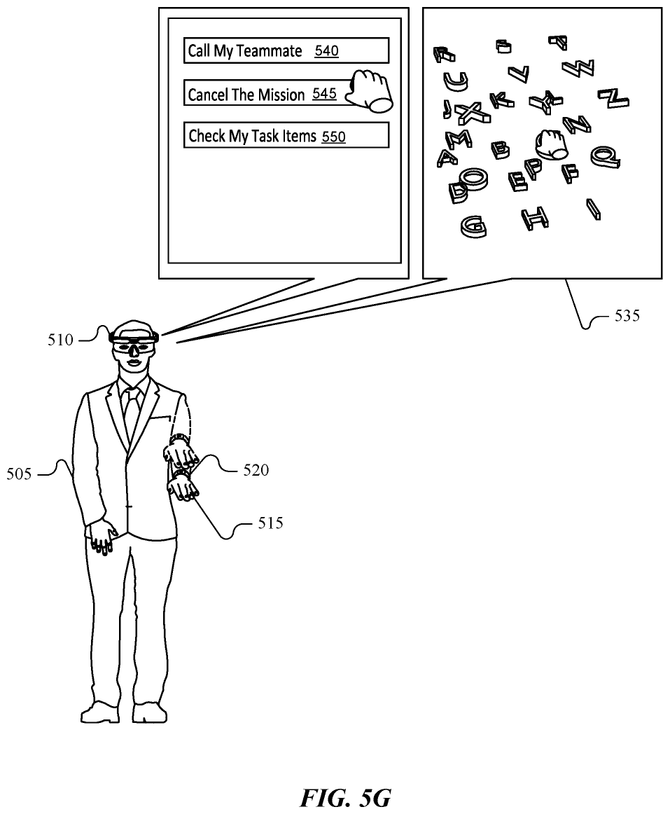

FIGS. 5A-5F illustrate an example use case of an XR cubic keyboard. FIG. 5A illustrates a user 505 wearing a head-mounted XR device 510. The user 505 may also wear an EMG wristband 515 on their wrist. The user 505 may raise their hand 520. Accordingly, the user 405 may see a virtual hand 525 via the display 530.

FIG. 5B illustrates the user 505 activating the XR cubic keyboard 535. The user 505 may then make a hand gesture as indicated by hand 525. The AR/VR system 130 may detect this hand gesture based on signals from the EMG wristband 515. The XR cubic keyboard 535 may be then activated. As illustrated in FIG. 5B, the XR cubic keyboard may include 26 cubis corresponding to the 26 English letters. 9 cubis may be located on a top plane, which include “R”, “S”, “T”, “U”, “V”, “W”, “X”, “Y”, and “Z”. Another 8 cubis may be located on a middle plane, which include “J”, “K”, “L”, “M”, “N”, “O”, “P”, and “Q”. The remaining 9 cubis may be located on a bottom plane, which include “A”, “B”, “C”, “D”, “E”, “F”, “G”, “H”, and “I”.

FIG. 5C illustrates the user 505 selecting a first letter. After activating the XR cubic keyboard, the user 505 may move their hand 520 along a vector upward. As illustrated in FIG. 5C, the virtual hand 525 may move right upward. The user 505 may then select letter “W”.

FIG. 5D illustrates the user 505 selecting a second letter. After activating the XR cubic keyboard, the user 505 may move their hand 520 along a vector downward. As illustrated in FIG. 5D, the virtual hand 525 may move right downward. The user 505 may then select letter “C”.

FIG. 5E illustrates example smart character suggestions. After the user selected “C” as illustrated in FIG. 5D, the AR/VR system 130 may generate one or more smart character suggestions. As shown in FIG. 5E, the smart character suggestions for the selected “C” may include “call my teammate 540”, “cancel the mission 545”, and “check my task items 550.”

FIG. 5F illustrates an example selection of a smart character suggestion. As illustrated in FIG. 5F, the user 505 may select a suggestion by a voice input 555, i.e., by saying “cancel the mission”. FIG. 5G illustrates another example selection of a smart character suggestion. As illustrated in FIG. 5G, the user 505 may select a suggestion by a hand gesture in a similar manner as illustrated in FIGS. 5A-5D. The user 505 may use their hand 520 to perform the hand gesture. Correspondingly, the virtual hand 525 may select the “cancel the mission 545” suggestion.

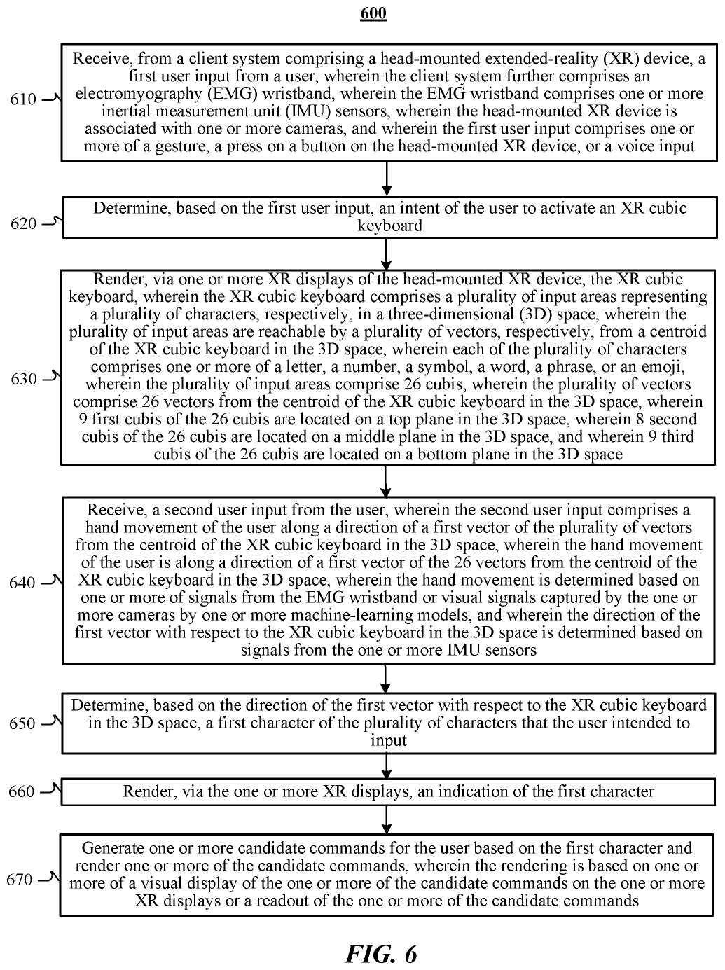

FIG. 6 illustrates an example method 600 for using an XR cubic keyboard for smart character suggestions. The method may begin at step 610, where the AR/VR system 130 may receive, from a client system 138 comprising a head-mounted extended-reality (XR) device, a first user input from a user, wherein the client system 138 further comprises an electromyography (EMG) wristband, wherein the EMG wristband comprises one or more inertial measurement unit (IMU) sensors, wherein the head-mounted XR device is associated with one or more cameras, and wherein the first user input comprises one or more of a gesture, a press on a button on the head-mounted XR device, or a voice input. At step 620, the AR/VR system 130 may determine, based on the first user input, an intent of the user to activate an XR cubic keyboard. At step 630, the AR/VR system 130 may render, via one or more XR displays of the head-mounted XR device, the XR cubic keyboard, wherein the XR cubic keyboard comprises a plurality of input areas representing a plurality of characters, respectively, in a three-dimensional (3D) space, wherein the plurality of input areas are reachable by a plurality of vectors, respectively, from a centroid of the XR cubic keyboard in the 3D space, wherein each of the plurality of characters comprises one or more of a letter, a number, a symbol, a word, a phrase, or an emoji, wherein the plurality of input areas comprise 26 cubis, wherein the plurality of vectors comprise 26 vectors from the centroid of the XR cubic keyboard in the 3D space, wherein 9 first cubis of the 26 cubis are located on a top plane in the 3D space, wherein 8 second cubis of the 26 cubis are located on a middle plane in the 3D space, and wherein 9 third cubis of the 26 cubis are located on a bottom plane in the 3D space. At step 640, the AR/VR system 130 may receive, a second user input from the user, wherein the second user input comprises a hand movement of the user along a direction of a first vector of the plurality of vectors from the centroid of the XR cubic keyboard in the 3D space, wherein the hand movement of the user is along a direction of a first vector of the 26 vectors from the centroid of the XR cubic keyboard in the 3D space, wherein the hand movement is determined based on one or more of signals from the EMG wristband or visual signals captured by the one or more cameras by one or more machine-learning models, and wherein the direction of the first vector with respect to the XR cubic keyboard in the 3D space is determined based on signals from the one or more IMU sensors. At step 650, the AR/VR system 130 may determine, based on the direction of the first vector with respect to the XR cubic keyboard in the 3D space, a first character of the plurality of characters that the user intended to input. At step 660, the AR/VR system 130 may render, via the one or more XR displays, an indication of the first character. At step 670, the AR/VR system 130 may generate one or more candidate commands for the user based on the first character and render one or more of the candidate commands, wherein the rendering is based on one or more of a visual display of the one or more of the candidate commands on the one or more XR displays or a readout of the one or more of the candidate commands. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for using an XR cubic keyboard for smart character suggestions including the particular steps of the method of FIG. 6, this disclosure contemplates any suitable method for using an XR cubic keyboard for smart character suggestions including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Systems and Methods

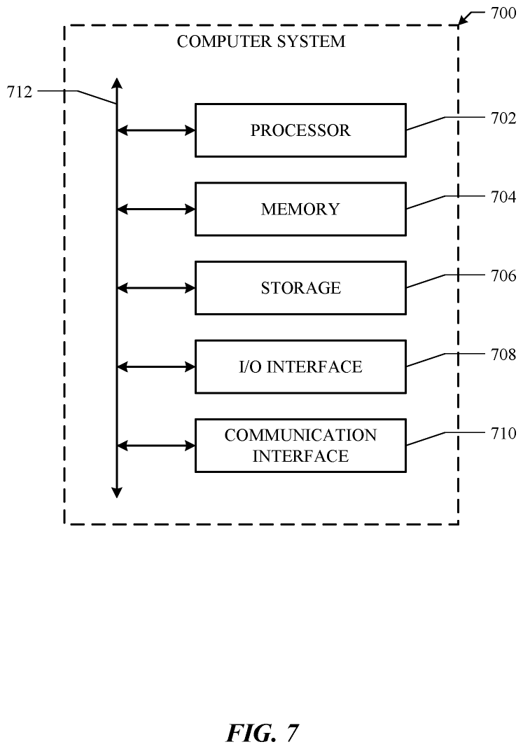

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Privacy

In particular embodiments, one or more objects (e.g., content or other types of objects) of a computing system may be associated with one or more privacy settings. The one or more objects may be stored on or otherwise associated with any suitable computing system or application, such as, for example, a social-networking system 160, an AR/VR system 130, an AR/VR platform 140, a third-party system 170, a social-networking application 134, an AR/VR application 136, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system 160 or VR platform 140 or shared with other systems (e.g., a third-party system 170). Although this disclosure describes using particular privacy settings in a particular manner, this disclosure contemplates using any suitable privacy settings in any suitable manner.

In particular embodiments, the social-networking system 160 or AR/VR platform 140 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system 160 or AR/VR platform 140 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and the object may be sent only to the user (or an AR/VR system 130 of the user) if the authorization server determines that the user is authorized to access the object based on the privacy settings associated with the object. If the requesting user is not authorized to access the object, the authorization server may prevent the requested object from being retrieved from the data store 164 or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system 160, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system 160 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system 160 or AR/VR platform 140 may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system 160 or AR/VR platform 140 may access such information in order to provide a particular function or service to the first user, without the social-networking system 160 or AR/VR platform 140 having access to that information for any other purposes. Before accessing, storing, or using such objects or information, the social-networking system 160 or AR/VR platform 140 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system 160 or AR/VR platform 140.

In particular embodiments, a user may specify whether particular types of objects or information associated with the first user may be accessed, stored, or used by the social-networking system 160 or AR/VR platform 140. As an example and not by way of limitation, the first user may specify that images sent by the first user through the social-networking system 160 or AR/VR platform 140 may not be stored by the social-networking system 160 or AR/VR platform 140. As another example and not by way of limitation, a first user may specify that messages sent from the first user to a particular second user may not be stored by the social-networking system 160 or AR/VR platform 140. As yet another example and not by way of limitation, a first user may specify that all objects sent via a particular application may be saved by the social-networking system 160 or AR/VR platform 140.

In particular embodiments, privacy settings may allow a first user to specify whether particular objects or information associated with the first user may be accessed from particular AR/VR systems 130 or third-party systems 170. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system 160 or AR/VR platform 140 may provide default privacy settings with respect to each device, system, or application, and/or the first user may be prompted to specify a particular privacy setting for each context. As an example and not by way of limitation, the first user may utilize a location-services feature of the social-networking system 160 or AR/VR platform 140 to provide recommendations for restaurants or other places in proximity to the user. The first user's default privacy settings may specify that the social-networking system 160 or AR/VR platform 140 may use location information provided from an AR/VR system 130 of the first user to provide the location-based services, but that the social-networking system 160 or AR/VR platform 140 may not store the location information of the first user or provide it to any third-party system 170. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, the social-networking system 160 or AR/VR platform 140 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the social-networking system 160 or AR/VR platform 140. The user's privacy settings may specify that such information may be used only for particular processes, such as authentication, and further specify that such information may not be shared with any third-party system 170 or used for other processes or applications associated with the social-networking system 160 or AR/VR platform 140. As another example and not by way of limitation, the social-networking system 160 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any third-party system 170 or used by other processes or applications associated with the social-networking system 160.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by one or more computing systems:
receiving, from a client system comprising a head-mounted extended-reality (XR) device, a first user input from a user;
determining, based on the first user input, an intent of the user to activate an XR cubic keyboard;
rendering, via one or more XR displays of the head-mounted XR device, the XR cubic keyboard, wherein the XR cubic keyboard comprises a plurality of input areas representing a plurality of characters, respectively, in a three-dimensional (3D) space, and wherein the plurality of input areas are reachable by a plurality of vectors, respectively, from a centroid of the XR cubic keyboard in the 3D space;
receiving, a second user input from the user, wherein the second user input comprises a hand movement of the user along a direction of a first vector of the plurality of vectors from the centroid of the XR cubic keyboard in the 3D space;
determining, based only on the direction of the first vector with respect to the XR cubic keyboard in the 3D space, a first character of the plurality of characters that the user intended to input; and
rendering, via the one or more XR displays, an indication of the first character.

2. The method of claim 1, wherein each of the plurality of characters comprises one or more of a letter, a number, a symbol, a word, a phrase, or an emoji.

3. The method of claim 1, wherein the plurality of input areas comprise 26 cubis, and wherein the plurality of vectors comprise 26 vectors from the centroid of the XR cubic keyboard in the 3D space.

4. The method of claim 3, wherein 9 first cubis of the 26 cubis are located on a top plane in the 3D space, wherein 8 second cubis of the 26 cubis are located on a middle plane in the 3D space, and wherein 9 third cubis of the 26 cubis are located on a bottom plane in the 3D space.

5. The method of claim 3, wherein the hand movement of the user is along a direction of a first vector of the 26 vectors from the centroid of the XR cubic keyboard in the 3D space.

6. The method of claim 1, wherein the first user input comprises one or more of a gesture, a press on a button on the head-mounted XR device, or a voice input.

7. The method of claim 1, further comprising:
determining the hand movement based on signals from an electromyography (EMG) wristband.

8. The method of claim 1, wherein the head-mounted XR device is associated with one or more cameras, wherein the method further comprises:
receiving, from the one or more cameras, visual signals captured by the one or more cameras; and
determining, based on the visual signals by one or more machine-learning models, the hand movement.

9. The method of claim 1, further comprising:
receiving, from the client system, a third user input via an electromyography (EMG) wristband, wherein the third user input comprises a gesture; and
determining, based on the gesture, the user confirms a selection of the first character.

10. The method of claim 9, further comprising:
rendering a confirmation with the user of the selected first character, wherein the rendering is based on one or more of a visual display of the selected first character on the one or more XR displays, a haptic feedback, or an audio feedback.

11. The method of claim 1, further comprising:
generating, based on the first character, one or more candidate commands for the user; and
rendering one or more of the candidate commands, wherein the rendering is based on one or more of a visual display of the one or more of the candidate commands on the one or more XR displays or a readout of the one or more of the candidate commands.

12. The method of claim 11, further comprising:
receiving, from the client system, a user selection of a first candidate command of the rendered candidate commands;
determining a first task corresponding to the first candidate command; and
executing the first task.

13. The method of claim 1, wherein the client system further comprises an electromyography (EMG) wristband, and wherein the EMG wristband comprises one or more inertial measurement unit (IMU) sensors, wherein the method further comprises:
determining the direction of the first vector with respect to the XR cubic keyboard in the 3D space based on signals from the one or more IMU sensors.

14. The method of claim 1, wherein the client system further comprises an electromyography (EMG) wristband, and wherein the first and second user inputs are received via the EMG wristband.

15. One or more computer-readable non-transitory non-volatile storage media embodying software that is operable when executed to:
receive, from a client system comprising a head-mounted extended-reality (XR) device, a first user input from a user;
determine, based on the first user input, an intent of the user to activate an XR cubic keyboard;
render, via one or more XR displays of the head-mounted XR device, the XR cubic keyboard, wherein the XR cubic keyboard comprises a plurality of input areas representing a plurality of characters, respectively, in a three-dimensional (3D) space, and wherein the plurality of input areas are reachable by a plurality of vectors, respectively, from a centroid of the XR cubic keyboard in the 3D space;
receive, a second user input from the user, wherein the second user input comprises a hand movement of the user along a direction of a first vector of the plurality of vectors from the centroid of the XR cubic keyboard in the 3D space;
determine, based only on the direction of the first vector with respect to the XR cubic keyboard in the 3D space, a first character of the plurality of characters that the user intended to input; and
render, via the one or more XR displays, an indication of the first character.

16. The media of claim 15, wherein each of the plurality of characters comprises one or more of a letter, a number, a symbol, a word, a phrase, or an emoji.

17. The media of claim 15, wherein the client system further comprises an electromyography (EMG) wristband, and wherein the EMG wristband comprises one or more inertial measurement unit (IMU) sensors, wherein the software is further operable when executed to:
determine the direction of the first vector with respect to the XR cubic keyboard in the 3D space based on signals from the one or more IMU sensors.

18. A system comprising: one or more processors; and a non-transitory non-volatile memory coupled to the processors comprising instructions executable by the processors, the processors operable when executing the instructions to:
receive, from a client system comprising a head-mounted extended-reality (XR) device, a first user input from a user;
determine, based on the first user input, an intent of the user to activate an XR cubic keyboard;
render, via one or more XR displays of the head-mounted XR device, the XR cubic keyboard, wherein the XR cubic keyboard comprises a plurality of input areas representing a plurality of characters, respectively, in a three-dimensional (3D) space, and wherein the plurality of input areas are reachable by a plurality of vectors, respectively, from a centroid of the XR cubic keyboard in the 3D space;
receive, a second user input from the user, wherein the second user input comprises a hand movement of the user along a direction of a first vector of the plurality of vectors from the centroid of the XR cubic keyboard in the 3D space;
determine, based only on the direction of the first vector with respect to the XR cubic keyboard in the 3D space, a first character of the plurality of characters that the user intended to input; and
render, via the one or more XR displays, an indication of the first character.

19. The system of claim 18, wherein each of the plurality of characters comprises one or more of a letter, a number, a symbol, a word, a phrase, or an emoji.

20. The system of claim 18, wherein the client system further comprises an electromyography (EMG) wristband, and wherein the EMG wristband comprises one or more inertial measurement unit (IMU) sensors, wherein the processors are further operable when executing the instructions to:
determine the direction of the first vector with respect to the XR cubic keyboard in the 3D space based on signals from the one or more IMU sensors.
